(19) United States
(12) Patent Application Publication
(10) Pub. No.: US 2017/0243467 A1
(43) Pub. Date: Aug. 24, 2017

(54) ALERT METHOD AND APPARATUS

(71) Applicant: Beijing Zhigu Rui Tuo Tech Co., Ltd, Beijing (CN)

(72) Inventor: Jia LIU, Beijing (CN)

(73) Assignee: Beijing Zhigu Rui Tuo Tech Co., Ltd, Beijing (CN)

(21) Appl. No.: 15/519,159

(22) PCT Filed: Jul. 24, 2015
(86) PCT No.: PCT/CN2015/085026

§ 371 Date: Apr. 14, 2017

(30) Foreign Application Priority Data
Oct. 17, 2014 (CN) 201410554366.3

(51) Int. Cl. G08B 21/24; G08B 21/18

(52) U.S. Cl. CPC G08B 21/24; G08B 21/182; H04W 4/021

(57) ABSTRACT

An alert method and apparatus are provided. A method comprises: determining, by an alert apparatus, that at least one object is placed in a placement region of an article holding apparatus associated with the alert apparatus; and alerting at least one user equipment (UE) corresponding to the placement region that the at least one object is placed on the article holding apparatus. An alert solution is provided, which is applicable regardless of whether the object has wireless communication capability.

### RELATED APPLICATION

The present international patent cooperative treaty (PCT) application claims the benefit of priority to Chinese Patent Application No. 201410554366.3, filed on Oct. 17, 2014, and entitled “Alert Method and Apparatus”, which is hereby incorporated into the present international PCT application by reference herein in its entirety.

### TECHNICAL FIELD

Embodiments of the present application relate to the field of communication technologies, and in particular, to an alert method and apparatus.

### BACKGROUND

When users go out from home, they sometimes forget articles such as mobile phones and keys. The existing BlueTooth (BT) 4.0 wireless communication technology supports a Proximity Profile, which can notify users when devices are away from each other to a certain extent by monitoring a change in signal strength between the devices, but the solution is not applicable to the articles, which have no wireless communication function.

### SUMMARY

In view of this, an example, non-limiting objective of embodiments of the present application is to provide an alert solution.

In one aspect, an example embodiment of the present application provides an alert method, comprising:

determining, by an alert apparatus, that at least one object is placed in a placement region of an article holding apparatus associated with the alert apparatus; and

alerting at least one user equipment (UE) corresponding to the placement region that the at least one object is placed on the article holding apparatus.

In another aspect, an example embodiment of the present application provides an alert apparatus, comprising:

a first determination module, configured to determine that at least one object is placed in a placement region of an article holding apparatus associated with the alert apparatus; and

an alert module, configured to alert at least one UE corresponding to the placement region that the at least one object is placed on the article holding apparatus.

In another aspect, an example embodiment of the present application provides an alert apparatus, comprising:

a first detection module, configured to detect whether at least one object is placed in a placement region of an article holding apparatus associated with the alert apparatus; and

a sending module, configured to, in response to that the first detection module detects that the at least one object is placed in the placement region, send an alert indicating that the at least one object is placed on the article holding apparatus to at least one UE corresponding to the placement region.

At least one technical solution in the foregoing technical solutions has one or more of the following beneficial effects:

the embodiments of the present application, by determining, by an alert apparatus, that at least one object is placed in a placement region of an article holding apparatus associated with the alert apparatus, and alerting at least one UE corresponding to the placement region that the at least one object is placed on the article holding apparatus, provide an alert solution, which is applicable regardless of whether the object has wireless communication capability.

### BRIEF DESCRIPTION OF THE DRAWINGS

FIG. 1 is a schematic flowchart of an example embodiment of an alert method according to the present application;

FIG. 2 is a schematic structural diagram of a first example embodiment of an alert apparatus according to the present application;

FIG. 3 and FIG. 4 are respectively schematic structural diagrams of one implementation of the example embodiment shown in FIG. 2;

FIG. 5 is a schematic structural diagram of a second example embodiment of an alert apparatus according to the present application;

FIG. 6 to FIG. 9 are respectively schematic structural diagrams of one implementation of the example embodiment shown in FIG. 5; and

FIG. 10 is a schematic structural diagram of a third example embodiment of an alert apparatus according to the present application.

### DETAILED DESCRIPTION

Example embodiments of the present application are further described in detail below with reference to the accompanying drawings and embodiments. The embodiments below are only used to describe the present application, but do not intend to limit the scope of the present application.

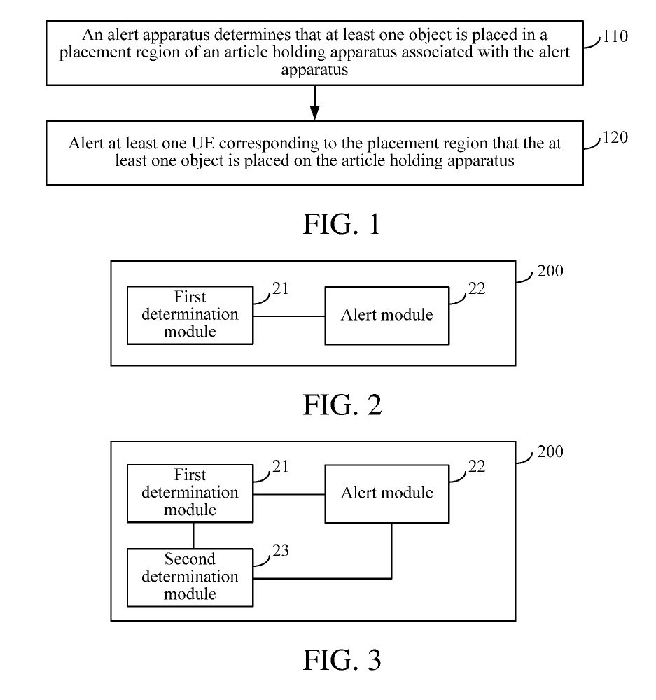

FIG. 1 is a schematic flowchart of an embodiment of an alert method according to the present application. As shown in FIG. 1, this embodiment comprises:

110. An alert apparatus determines that at least one object is placed in a placement region of an article holding apparatus associated with the alert apparatus.

In this embodiment, the alert apparatus is optionally an apparatus in the first or second or third embodiment of the alert apparatus according to the present application.

In this embodiment, the article holding apparatus is an apparatus configured to place articles, such as a table, a table mat, a shelf, a drawer or a chest.

In this embodiment, the alert apparatus and the article holding apparatus associated with the alert apparatus are usually set together. For example, the article holding apparatus is a table, and the alert apparatus is attached to or embedded into the table top of the table, and optionally, the alert apparatus is attached to an upper side or a lower side of the table top.

In this embodiment, the article holding apparatus comprises at least one placement region, and the at least one placement region may be divided in advance.

120. Alert at least one UE corresponding to the placement region that the at least one object is placed on the article holding apparatus.

In this embodiment, each of the at least one UE is generally a device easy to prompt users. Optionally, each of the at least one UE is a portable device, such as a mobile phone, a smartband, or a smart necklace. For example, an article A is placed in a first placement region of a table, an article B is placed in a second placement region, the first placement region corresponds to a mobile phone of a first user, the second placement region corresponds to a smartband of a second user, and correspondingly, the alert apparatus alerts the mobile phone of the first user that the article A is placed on the table and alerts the smartband of the second user that the article B is placed on the table.

In this embodiment, after 120, the at least one UE may alert at least one corresponding user.

This embodiment, by determining, by an alert apparatus, that at least one object is placed in a placement region of an article holding apparatus associated with the alert apparatus, and alerting at least one UE corresponding to the placement region that the at least one object is placed on the article holding apparatus, provides an alert solution, which is applicable no matter whether the object has wireless communication capability.

The method of this embodiment is further described below through some example embodiments.

In this embodiment, optionally, before the alerting at least one UE corresponding to the placement region that the at least one object is placed on the article holding apparatus, the method further comprises:

determining at least one UE corresponding to the placement region according to a corresponding relationship between placement region(s) and UE(s).

Optionally, the article holding apparatus comprises a plurality of placement regions, and in the corresponding relationship between placement region(s) and UE(s), at least one UE corresponding to each placement region may be the same or different.

In this embodiment, the alert apparatus may immediately perform 120 after 110, or may perform 120 only if a certain condition is met after 110.

In one example embodiment, the alerting at least one UE corresponding to the placement region that the at least one object is placed on the article holding apparatus comprises:

alerting a first UE that the at least one object is placed on the article holding apparatus in response to that a query request from the first UE in the at least one UE corresponding to the placement region is received.

The first UE may be any one of the at least one UE.

In another example embodiment, the alerting at least one UE corresponding to the placement region that the at least one object is placed on the article holding apparatus comprises:

alerting a second UE that the at least one object is placed on the article holding apparatus in response to that the second UE in the at least one UE corresponding to the placement region is located in a preset region.

The preset region may be a region set previously, such as a doorway.

Whether the second UE is located in a preset region may be determined in many manners, which comprise, but are not limited to: the alert apparatus detects the position of the second UE and judges whether the second UE is located in a preset region, or the second UE detects its own position, judges whether the second UE is located in a preset region and notifies the alert apparatus of the result, or the second UE detects its own position and notifies the alert apparatus of the position, and the alert apparatus determines whether the second UE is located in a preset region, or a third-party device other than the alert apparatus and the second UE detects the position of the second UE, judges whether the second UE is located in a preset region and notifies the alert apparatus of the result, or the like.

The second UE may be any one of the at least one UE. Specifically, with respect to each UE in the at least one UE, the preset region may be the same or different.

In another example embodiment, the alerting at least one UE corresponding to the placement region that the at least one object is placed on the article holding apparatus comprises:

alerting a third UE that the at least one object is placed on the article holding apparatus in response to that a distance between the third UE in the at least one UE corresponding to the placement region and the article holding apparatus exceeds a distance threshold.

Whether a distance between the third UE and the article holding apparatus exceeds a distance threshold may be determined in many manners, which comprise, but are not limited to: the alert apparatus detects positions of the article holding apparatus and the third UE and judges whether a distance therebetween exceeds a distance threshold, or the third UE detects its own position and the position of the article holding apparatus, judges whether a distance therebetween exceeds a distance threshold and notifies the alert apparatus of the result, or the third UE detects its own position and notifies the alert apparatus of the position, and the alert apparatus detects the position of the article holding apparatus and judges whether a distance between the third UE and the article holding apparatus exceeds a distance threshold, or a third-party device other than the alert apparatus and the third UE detects the position of the article holding apparatus and the position of the third UE, judges whether a distance therebetween exceeds a distance threshold and notifies the alert apparatus of the result, or the like.

The third UE may be any one of the at least one UE. Specifically, with respect to each UE in the at least one UE, the distance threshold may be the same or different.

As the alert apparatus and the article holding apparatus associated with the alert apparatus are usually set together, the distance between the third UE and the alert apparatus is equivalent to the distance between the third UE and the article holding apparatus.

It is noted that, in the example embodiment that the alert apparatus immediately performs 120 after 110, the UE alerted by the alert apparatus may also alert the user according to the alert of the alert apparatus when any of the above conditions is met, for example, the UE alerts the user that the at least one object is placed on the article holding apparatus in response to determining that the UE is located in a preset region.

In this embodiment, in order to identify the at least one object placed on the article holding apparatus, optionally, this embodiment further comprises: acquiring, by the alert apparatus, placement information of the at least one object.

The placement information optionally comprises at least one of the following: an image, a shape, weight and a material. Specifically, various kinds of placement information may be detected through corresponding sensors. For example, the image of each object may be detected through a visual sensor; the shape of each object may be detected through an ultrasonic distance sensor, an infrared sensor or the like; the weight of each object may be detected through various weighing sensors, for example, a resistance strain weighing sensor, an electromagnetic weighing sensor, a capacitance weighing sensor and the like; the material of each object may be detected through an inductive proximity sensor, a capacitive proximity sensor, a Hall proximity sensor, a photoelectric sensor or the like.

In order to achieve a clearer alert, optionally, the alerting at least one UE corresponding to the placement region that the at least one object is placed on the article holding apparatus comprises: sending the placement information of the at least one object to the at least one UE.

That is to say, the placement information of the at least one object is taken as the alert.

For example, after receiving a query request from a first UE in the at least one UE, the alert apparatus sends the placement information of the at least one object to the first UE.

In this embodiment, optionally, at least one article is placed in a plurality of placement regions of the article holding apparatus respectively, and correspondingly, at least one UE corresponding to each placement region can be alerted that the at least one article placed in the corresponding placement region is placed on the article holding apparatus.

FIG. 2 is a schematic structural diagram of a first embodiment of an alert apparatus according to the present application. As shown in FIG. 2, the alert apparatus 200 comprises:

a first determination module 21, configured to determine that at least one object is placed in a placement region of an article holding apparatus associated with the alert apparatus 200; and

an alert module 22, configured to alert at least one UE corresponding to the placement region that the at least one object is placed on the article holding apparatus.

In this embodiment, the article holding apparatus is an apparatus configured to place articles, such as a table, a table mat, a shelf, a drawer or a chest.

In this embodiment, the alert apparatus 200 and the article holding apparatus associated with the alert apparatus 200 are usually set together. For example, the article holding apparatus is a table, and the alert apparatus 200 is attached to or embedded into the table top of the table, and optionally, the alert apparatus 200 is attached to an upper side or a lower side of the table top.

In this embodiment, the article holding apparatus comprises at least one placement region, and the at least one placement region may be divided in advance.

In this embodiment, each of the at least one UE is generally a device easy to prompt users. Optionally, each of the at least one UE is a portable device, such as a mobile phone, a smartband, or a smart necklace. For example, the first determination module 21 determines that an article A is placed in a first placement region of a table associated with the alert apparatus 200, an article B is placed in a second placement region, the first placement region corresponds to a mobile phone of a first user, the second placement region corresponds to a smartband of a second user, and correspondingly, the alert module 22 alerts the mobile phone of the first user that the article A is placed on the table and alerts the smartband of the second user that the article B is placed on the table.

In this embodiment, after being alerted by the alert module 22, the at least one UE may alert the user.

The alert apparatus in this embodiment, by determining, by a first determination module, that at least one object is placed in a placement region of an article holding apparatus associated with the alert apparatus, and alerting, by an alert module, at least one UE corresponding to the placement region that the at least one object is placed on the article holding apparatus, provides an alert solution, which is applicable no matter whether the object has wireless communication capability.

The alert apparatus 200 in this embodiment is further described below through some example embodiments.

In this embodiment, optionally, as shown in FIG. 3, the alert apparatus 200 further comprises: a second determination module 23, configured to determine at least one UE corresponding to the placement region according to a corresponding relationship between placement region(s) and UE(s).

Optionally, the article holding apparatus comprises a plurality of placement regions, and in the corresponding relationship between placement region(s) and UE(s), at least one UE corresponding to each placement region may be the same or different.

In this embodiment, the alert module 22 may immediately alert the at least one UE after determination of the first determination module 21, or may alert the at least one UE only if a certain condition is met after determination of the first determination module 21.

In one example embodiment, the alert module 22 is specifically configured to:

alert a first UE that the at least one object is placed on the article holding apparatus in response to that a query request from the first UE in the at least one UE corresponding to the placement region is received.

The first UE may be any one of the at least one UE.

In another example embodiment, the alert module 22 is specifically configured to:

alert a second UE that the at least one object is placed on the article holding apparatus in response to that the second UE in the at least one UE corresponding to the placement region is located in a preset region.

The preset region may be a region set previously, such as a doorway.

The second UE may be any one of the at least one UE. Specifically, with respect to each UE in the at least one UE, the preset region may be the same or different.

Whether the second UE is located in a preset region may be determined in many manners, which comprise, but are not limited to: the alert apparatus 200 detects the position of the second UE and judges whether the second UE is located in a preset region, or the second UE detects its own position, judges whether the second UE is located in a preset region and notifies the alert apparatus 200 of the result, or the second UE detects its own position and notifies the alert apparatus 200 of the position, and the alert apparatus 200 determines whether the second UE is located in a preset region, or a third-party device other than the alert apparatus 200 and the second UE detects the position of the second UE, judges whether the second UE is located in a preset region and notifies the alert apparatus 200 of the result, or the like.

In another example embodiment, the alert module 22 is specifically configured to:

alert a third UE that the at least one object is placed on the article holding apparatus in response to that a distance between the third UE in the at least one UE corresponding to the placement region and the article holding apparatus exceeds a distance threshold.

The third UE may be any one of the at least one UE. Specifically, with respect to each UE in the at least one UE, the distance threshold may be the same or different.

Whether a distance between the third UE and the article holding apparatus exceeds a distance threshold may be determined in many manners, which comprise, but are not limited to: the alert apparatus 200 detects positions of the article holding apparatus and the third UE and judges whether a distance therebetween exceeds a distance threshold, or the third UE detects its own position and the position of the article holding apparatus, judges whether a distance therebetween exceeds a distance threshold and notifies the alert apparatus 200 of the result, or the third UE detects its own position and notifies the alert apparatus 200 of the position, and the alert apparatus 200 detects the position of the article holding apparatus and judges whether a distance between the third UE and the article holding apparatus exceeds a distance threshold, or a third-party device other than the alert apparatus 200 and the third UE detects the position of the article holding apparatus and the position of the third UE, judges whether a distance therebetween exceeds a distance threshold and notifies the alert apparatus 200 of the result, or the like.

As the alert apparatus 200 and the article holding apparatus associated with the alert apparatus 200 are usually set together, the distance between the third UE and the alert apparatus 200 is equivalent to the distance between the third UE and the article holding apparatus.

It is noted that, in the example embodiment that the alert module 22 immediately alerts the at least one UE after determination of the first determination module 21, the UE alerted by the alert module 22 may also alert the user according to the alert of the alert module 22 when any of the above conditions is met, for example, the UE alerts the user that the at least one object is placed on the article holding apparatus in response to determining that the UE is located in a preset region.

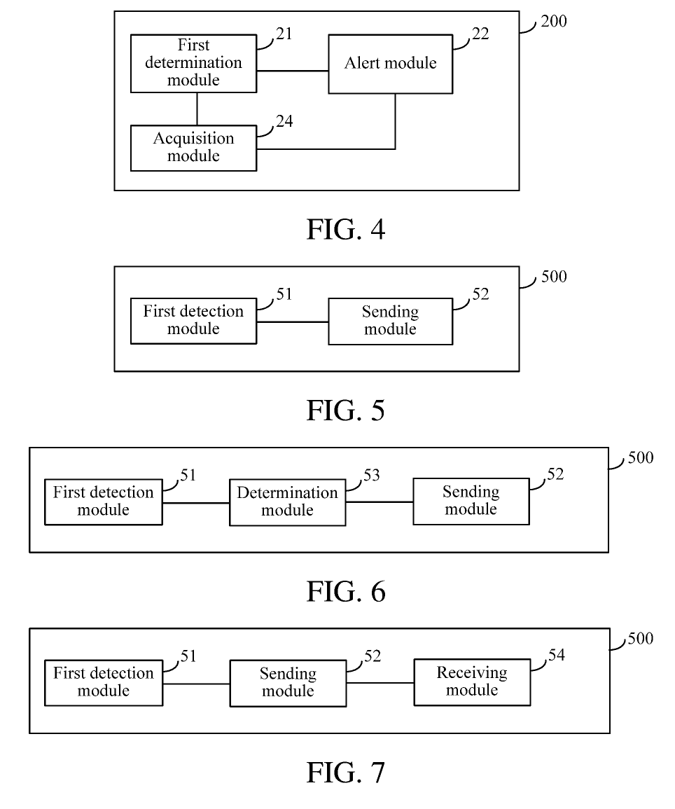

In this embodiment, in order to identify the object placed on the article holding apparatus, optionally, as shown in FIG. 4, the alert apparatus 200 further comprises: an acquisition module 24, configured to acquire placement information of the at least one object.

The placement information optionally comprises at least one of the following: an image, a shape, weight and a material. Specifically, various kinds of placement information may be detected through corresponding sensors. For example, the image of each object may be detected through a visual sensor; the shape of each object may be detected through an ultrasonic distance sensor, an infrared sensor or the like; the weight of each e object may be detected through various weighing sensors, for example, a resistance strain weighing sensor, an electromagnetic weighing sensor, a capacitance weighing sensor and the like; the material of each object may be detected through an inductive proximity sensor, a capacitive proximity sensor, a Hall proximity sensor, a photoelectric sensor or the like.

In order to achieve a clearer alert, optionally, the alert module 22 is specifically configured to: send the placement information of the at least one object to the at least one UE.

That is to say, the placement information of the at least one object is taken as the alert.

For example, after receiving a query request from a first UE in the at least one UE, the alert module 22 sends the placement information of the at least one object to the first UE.

In this embodiment, optionally, the first determination module 21 determines that at least one article is placed in a plurality of placement regions of the article holding apparatus respectively, and correspondingly, the alert module 22 respectively alerts at least one UE corresponding to each placement region that the at least one article placed in the corresponding placement region is placed on the article holding apparatus.

FIG. 5 is a schematic structural diagram of a second embodiment of an alert apparatus according to the present application. As shown in FIG. 5, the alert apparatus 500 comprises:

a first detection module 51, configured to detect whether at least one object is placed in a placement region of an article holding apparatus associated with the alert apparatus 500; and

a sending module 52, configured to, in response to that the first detection module 51 detects that the at least one object is placed in the placement region, send an alert indicating that the at least one object is placed on the article holding apparatus to at least one UE corresponding to the placement region.

In this embodiment, the article holding apparatus is an apparatus configured to place articles, such as a table, a table mat, a shelf, a drawer or a chest.

In this embodiment, the alert apparatus 500 and the article holding apparatus associated with the alert apparatus 500 are usually set together. For example, the article holding apparatus is a table, and the alert apparatus 500 is attached to or embedded into the table top of the table, and optionally, the alert apparatus 500 is attached to an upper side or a lower side of the table top.

In this embodiment, the article holding apparatus comprises at least one placement region, and the at least one placement region may be divided in advance.

In this embodiment, each of the at least one UE is generally a device easy to prompt users. Optionally, each of the at least one UE is a portable device, such as a mobile phone, a smartband, or a smart necklace. For example, the first detection module 51 detects that an article A is placed in a first placement region of a table associated with the alert apparatus 500, an article B is placed in a second placement region, the first placement region corresponds to a mobile phone of a first user, the second placement region corresponds to a smartband of a second user, and the sending module 52 sends to the mobile phone of the first user an alert indicating that the article A is placed on the table and sends to the smartband of the second user an alert indicating that the article B is placed on the table.

In this embodiment, the sending module 52 sends the alert to the at least one UE by using a wireless communication technology. The wireless communication technology comprises, but is not limited to, BT, WiFi, Zigbee, infrared and the like. Optionally, the sending module 52 and the at least one UE perform communication by using a BT wireless communication technology, and correspondingly, the sending module 52 comprises a BT communication unit.

In this embodiment, after receiving the alert sent by the sending module 52, the at least one UE may alert at least one corresponding user.

The alert apparatus in this embodiment, by detecting, by a first detection module, whether at least one object is placed in a placement region of an article holding apparatus associated with the alert apparatus, and in response to that the first detection module detects that the at least one object is placed in the placement region, sending, by a sending module, an alert indicating that the at least one object is placed on the article holding apparatus to at least one UE corresponding to the placement region, provides an alert solution, which is applicable no matter whether the object has wireless communication capability.

The alert apparatus 500 of this embodiment is further described below through some example embodiments.

In this embodiment, optionally, as shown in FIG. 6, the alert apparatus 500 further comprises: a determination module 53, configured to determine at least one UE corresponding to the placement region according to a corresponding relationship between placement region(s) and UE(s).

Optionally, the article holding apparatus comprises a plurality of placement regions, and in the corresponding relationship between placement region(s) and UE(s), at least one UE corresponding to each placement region may be the same or different.

In this embodiment, the sending module 52 may immediately send the alert after the first detection module 51 detects that at least one object is placed in the placement region, and may also send the alert only if it is determined that a certain condition is met after the first detection module 51 detects that at least one object is placed in the placement region.

In one example embodiment, as shown in FIG. 7, the alert apparatus 500 further comprises: a receiving module 54, configured to receive a query request from the at least one UE corresponding to the placement region; and

the sending module 52 is specifically configured to: in response to that the receiving module 54 receives a query request from a first UE in the at least one UE corresponding to the placement region, send to the first UE an alert indicating that the at least one object is placed on the article holding apparatus.

Specifically, the receiving module 54 and the at least one UE perform communication by using a wireless communication technology. The wireless communication technology comprises, but is not limited to, BT, WiFi, Zigbee, infrared and the like. Optionally, the wireless communication technology is a BT wireless communication technology, and correspondingly, the receiving module 54 comprises a BT communication unit, and further optionally, the receiving module 54 and the sending module 52 share the same BT communication unit.

The first UE may be any one of the at least one UE.

In another example embodiment, the sending module 52 is specifically configured to: in response to that a second UE in the at least one UE corresponding to the placement region is located in a preset region, send to the second UE an alert indicating that the at least one object is placed on the article holding apparatus.

The preset region may be a region set previously, such as a doorway.

The second UE may be any one of the at least one UE. Specifically, with respect to each UE in the at least one UE, the preset region may be the same or different.

Specifically, whether the second UE is located in a preset region may be determined in many manners, which comprise, but are not limited to: the alert apparatus 500 detects the position of the second UE and judges whether the second UE is located in a preset region, or the second UE detects its own position, judges whether the second UE is located in a preset region and notifies the alert apparatus 500 of the result, or the second UE detects its own position and notifies the alert apparatus 500 of the position, and the alert apparatus 500 determines whether the second UE is located in a preset region, or a third-party device other than the alert apparatus 500 and the second UE detects the position of the second UE, judges whether the second UE is located in a preset region and notifies the alert apparatus 500 of the result, or the like.

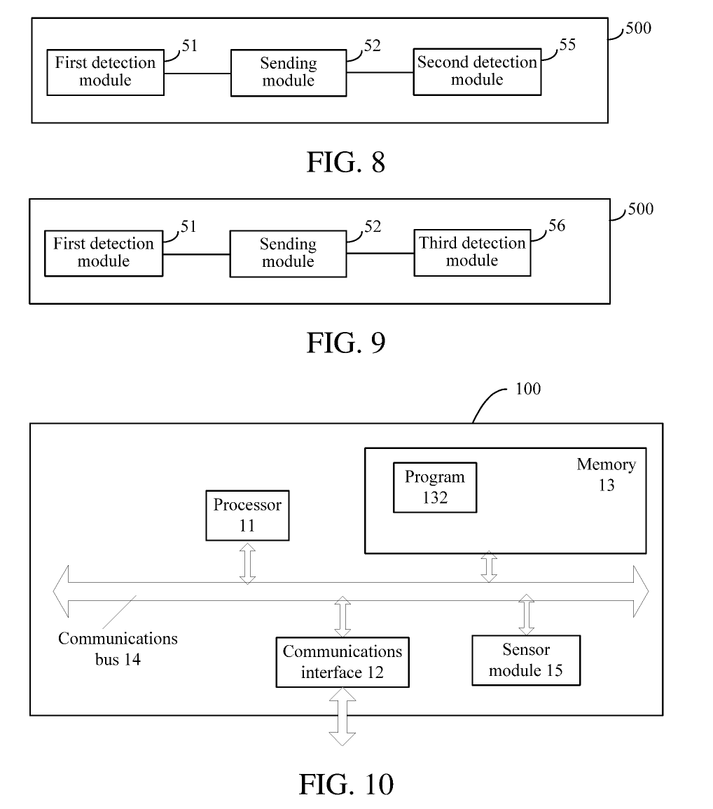

In the implementation, optionally, as shown in FIG. 8, the alert apparatus 500 further comprises: a second detection module 55, configured to detect whether the second UE is located in a preset region.

In another example embodiment, the sending module 52 is specifically configured to: in response to that a distance between a third UE in the at least one UE corresponding to the placement region and the article holding apparatus exceeds a distance threshold, send to the third UE an alert indicating that the at least one object is placed on the article holding apparatus.

The third UE may be any one of the at least one UE. Specifically, with respect to each UE in the at least one UE, the distance threshold may be the same or different.

Specifically, whether a distance between the third UE and the article holding apparatus exceeds a distance threshold may be determined in many manners, which comprise, but are not limited to: the alert apparatus 500 detects positions of the article holding apparatus and the third UE and judges whether a distance therebetween exceeds a distance threshold, or the third UE detects its own position and the position of the article holding apparatus, judges whether a distance therebetween exceeds a distance threshold and notifies the alert apparatus 500 of the result, or the third UE detects its own position and notifies the alert apparatus 500 of the position, and the alert apparatus 500 detects the position of the article holding apparatus and judges whether a distance between the third UE and the article holding apparatus exceeds a distance threshold, or a third-party device other than the alert apparatus 500 and the third UE detects the position of the article holding apparatus and the position of the third UE, judges whether a distance therebetween exceeds a distance threshold and notifies the alert apparatus 500 of the result, or the like.

In the implementation, optionally, as shown in FIG. 9, the alert apparatus 500 further comprises: a third detection module 56, configured to detect whether the distance between the third UE and the article holding apparatus exceeds a distance threshold.

As the alert apparatus 500 and the article holding apparatus associated with the alert apparatus 500 are usually set together, the distance between the third UE and the alert apparatus 500 is equivalent to the distance between the third UE and the article holding apparatus. Correspondingly, the third detection module 56 is specifically configured to detect whether a distance between the third UE and the alert apparatus 500 exceeds a distance threshold, and the sending module 52 is specifically configured to: in response to that the third detection module 56 detects that a distance between a third UE in the at least one UE corresponding to the placement region and the alert apparatus 500 exceeds a distance threshold, send to the third UE an alert indicating that the at least one object is placed on the article holding apparatus. Optionally, the third detection module 56 comprises: a distance sensor.

It is noted that, in the example embodiment that the sending module 52 immediately sends the alert to the at least one UE after the first detection module 51 detects that at least one object is placed in the placement region, the UE receiving the alert sent by the sending module 52 may also alert the user when any of the above conditions is met, for example, the UE alerts the user that the at least one object is placed on the article holding apparatus in response to determining that the UE is located in a preset region.

In this embodiment, the first detection module 51 may comprise at least one sensor. In order to detect whether at least one object is placed in a placement region on the article holding apparatus, optionally, the first detection module 51 comprises any one of the following: a visual sensor or a weighing sensor. For example, the visual sensor can acquire visual images of the placement region, so as to determine whether at least one object is placed in the placement region; and the weighting sensor can detect load-bearing in the placement region, and determine whether at least one object is placed in the placement region.

In this embodiment, in order to identify the object placed on the article holding apparatus, optionally, the first detection module 51 is further configured to: detect placement information of the at least one object.

The placement information optionally comprises at least one of the following: an image, a shape, weight and a material. Specifically, various kinds of placement information may be detected through corresponding sensors comprised in the first detection module 51. For example, the image of each object may be detected through a visual sensor; the shape of each object may be detected through an ultrasonic distance sensor, an infrared sensor or the like; the weight of each object may be detected through various weighing sensors, for example, a resistance strain weighing sensor, an electromagnetic weighing sensor, a capacitance weighing sensor and the like; the material of each object may be detected through an inductive proximity sensor, a capacitive proximity sensor, a Hall proximity sensor, a photoelectric sensor or the like.

In order to achieve a clearer alert, optionally, the sending module 52 is specifically configured to: send the placement information of the at least one object to the at least one UE.

That is to say, the sending module 52 takes placement information of the at least one object as the alert.

For example, after the receiving module 54 receives a query request from a first UE in the at least one UE, the sending module 52 sends the placement information of the at least one object to the first UE.

In this embodiment, optionally, the article holding apparatus comprises a plurality of placement regions, the first detection module 51 detects whether at least one object is placed in each placement region, and correspondingly, the sending module 52, in response to that the first detection module 51 detects at least one placement region where at least one object is placed, respectively alerts at least one UE corresponding to the at least one placement region that the at least one object placed in the corresponding placement region is placed on the article holding apparatus.

FIG. 10 is a schematic structural diagram of a third embodiment of an alert apparatus according to the present application. As shown in FIG. 10, the alert apparatus 100 comprises:

a processor 11, a communications interface 12, a memory 13, and a communications bus 14.

The processor 11, the communications interface 12, and the memory 13 accomplish mutual communications via the communications bus 14.

The communications interface 12 is configured to communicate with an external device such as a UE.

The processor 11 is configured to execute a program 132, and specifically, can implement relevant steps in the embodiments of the alert method.

Specifically, the program 132 may comprise a program code, the program code comprising a computer operation instruction.

The processor 11 may be a central processing unit (CPU), or an application specific integrated circuit (ASIC), or be configured to be one or more integrated circuits which implement the embodiments of the alert method.

The memory 13 is configured to store the program 132. The memory 13 may comprise a high-speed RAM memory, and may also comprise a non-volatile memory, for example, at least one magnetic disk memory. The program 132 may be specifically configured to cause the alert apparatus 100 to implement the following steps:

determining that at least one object is placed in a placement region of an article holding apparatus associated with the alert apparatus 100; and

alerting at least one UE corresponding to the placement region that the at least one object is placed on the article holding apparatus.

Reference can be made to the corresponding description in the corresponding embodiments of the alert method for specific implementation of the steps in the program 132, which is not repeated herein.

Optionally, the alert apparatus 100 further comprises: a sensor module 15 which comprises various kinds of sensors.

Those skilled in the art can clearly understand that, reference can be made to the corresponding process description in the embodiments of the alert method for the apparatus described above and the specific working procedures of the modules, and will not be repeated herein in order to make the description convenient and concise.

It can be appreciated by those of ordinary skill in the art that each exemplary unit and method step described with reference to the embodiments disclosed herein can be implemented by electronic hardware or a combination of computer software and electronic hardware. Whether these functions are executed in a hardware mode or a software mode depends on particular applications and design constraint conditions of the technical solution. The professional technicians can use different methods to implement the functions described with respect to each particular application, but such implementation should not be considered to go beyond the scope of the present application.

If the functions are implemented in the form of a software functional unit and is sold or used as an independent product, it can be stored in a computer-readable storage medium. Based on such understanding, the technical solution of the present application essentially or the part which contributes to the prior art or a part of the technical solution can be embodied in the form of a software product, and the computer software product is stored in a storage medium, and comprises several instructions for enabling a computer device (which can be a personal computer, a server, or a network device, and the like) to execute all or some steps of the method described in each embodiment of the present application. The foregoing storage medium comprises, a USB disk, a removable hard disk, a read-only memory (ROM), a random access memory (RAM), a magnetic disk, an optical disk or any other mediums that can store program codes.

The above implementations are only intended to describe the present application rather than to limit the present application; various changes and variations can be made by those of ordinary skill in the art without departing from the spirit and scope of the present application, so all equivalent technical solutions also belong to the category of the present application, and the scope of patent protection of the present application should be defined by the claims.

What is claimed is:

1. A method, comprising:
determining, by an alert apparatus comprising a processor, that at least one object has been placed in a placement region of an article holding apparatus associated with the alert apparatus; and
alerting at least one user equipment (UE) corresponding to the placement region that the at least one object has been placed on the article holding apparatus.

2. The method of claim 1, wherein the article holding apparatus comprises at least one placement region.

3. The method of claim 2, further comprising, before the alerting, determining the at least one UE corresponding to the placement region according to a corresponding relationship between placement regions and UEs.

4. The method of claim 1, wherein the alerting comprises:
alerting a first UE that the at least one object has been placed on the article holding apparatus in response to determining that a query request from the first UE in the at least one UE corresponding to the placement region has been received; or
alerting a second UE that the at least one object has been placed on the article holding apparatus in response to determining that the second UE in the at least one UE corresponding to the placement region is located in a preset region; or
alerting a third UE that the at least one object has been placed on the article holding apparatus in response to determining that a distance between the third UE in the at least one UE corresponding to the placement region and the article holding apparatus has exceeded a distance threshold.

5. The method of claim 1, further comprising: acquiring, by the alert apparatus, placement information of the at least one object.

6. The method of claim 5, wherein the placement information comprises at least one of an image, a shape, weight or a material.

7. The method of claim 5, wherein the alerting comprises: sending the placement information of the at least one object to the at least one UE.

8. The method of claim 1, wherein the article holding apparatus is a table, and the alert apparatus is attached to or embedded into a table top of the table.

9. The method of claim 1, wherein each of the at least one UE is a portable device.

10. An apparatus, comprising:
a memory that stores executable modules; and
a processor, couple to the memory, that executes or facilitates execution of the executable modules, the executable modules comprising:
a first determination module configured to determine that at least one object is placed in a placement region of an article holding apparatus associated with the apparatus; and
an alert module configured to alert at least one user equipment (UE) corresponding to the placement region that the at least one object is placed on the article holding apparatus.

11. The apparatus of claim 10, wherein the article holding apparatus comprises at least one placement region.

12. The apparatus of claim 11, wherein the executable modules further comprise: a second determination module configured to determine the at least one UE corresponding to the placement region according to a corresponding mapping between placement regions and UEs.

13. The apparatus of claim 10, wherein the alert module is further configured to:
alert a first UE that the at least one object is placed on the article holding apparatus in response to determining that a query request from the first UE in the at least one UE corresponding to the placement region has been received; or
alert a second UE that the at least one object is placed on the article holding apparatus in response to determining that the second UE in the at least one UE corresponding to the placement region is located in a preset region; or
alert a third UE that the at least one object is placed on the article holding apparatus in response to determining that a distance between the third UE in the at least one UE corresponding to the placement region and the article holding apparatus has exceeded a distance threshold.

14. The apparatus of claim 10, wherein the executable modules further comprise:
an acquisition module configured to acquire placement information of the at least one object.

15. The apparatus of claim 14, wherein the placement information comprises at least one of an image, a shape, weight or a material.

16. The apparatus of claim 14, wherein the alert module is further configured to: send the placement information of the at least one object to the at least one UE.

17. An apparatus, comprising:
a memory that stores executable modules; and
a processor, couple to the memory, that executes or facilitates execution of the executable modules, the executable modules comprising:
a first detection module configured to detect whether an object has been placed in a placement region of an article holding apparatus associated with the apparatus; and
a sending module configured to, in response to a determination that the first detection module has detected that the object has been placed in the placement region, send an alert indicating that the object has been placed on the article holding apparatus to a user equipment (UE) corresponding to the placement region.

18. The apparatus of claim 17, wherein the article holding apparatus comprises the placement region.

19. The apparatus of claim 18, wherein the executable modules further comprise: a determination module configured to determine the UE corresponding to the placement region according to a corresponding relationship between the placement region and the UE.

20. The apparatus of claim 17, wherein the executable modules further comprise: a receiving module configured to receive a query request from the UE corresponding to the placement region; and
the sending module is further configured to: in response to a determination that the receiving module has received a query request from the UE corresponding to the placement region, send to the UE an alert indicating that the object has been placed on the article holding apparatus.

21. The apparatus of claim 17, wherein the sending module is further configured to: in response to a determination that the UE corresponding to the placement region is located in a preset region, send to the UE an alert indicating that the object is placed on the article holding apparatus.

22. The apparatus of claim 21, wherein the executable modules further comprise: a second detection module configured to detect whether the UE is located in a preset region.

23. The apparatus of claim 17, wherein the sending module is further configured to: in response to a determination that a distance between the UE corresponding to the placement region and the article holding apparatus has exceeded a distance threshold, send to the UE an alert indicating that the object has been placed on the article holding apparatus.

24. The apparatus of claim 23, wherein the executable modules further comprise: a third detection module configured to detect whether the distance between the UE and the article holding apparatus has exceeded a distance threshold.

25. The apparatus of claim 17, wherein the detection module comprises at least one of a visual sensor or a weighing sensor.

26. The apparatus of claim 17, wherein the first detection module is further configured to: detect placement information of the object.

27. The apparatus of claim 26, wherein the placement information comprises at least one of an image, a shape, weight or a material.

28. The apparatus of claim 26, wherein the sending module is further configured to: send the placement information of the object to the UE.

29. The apparatus of claim 17, wherein the article holding apparatus is a table, and the apparatus is attached to or embedded into a table top of the table.

30. A computer readable storage device comprising executable instructions that, in response to execution, cause a device comprising a processor to perform operations, comprising:
determining that at least one object has been placed in a placement region of an article holding apparatus associated with the device; and
alerting at least one user equipment (UE) corresponding to the placement region that the at least one object has been placed on the article holding apparatus.
